(19) United States
(12) Patent Application Publication
(10) Pub. No.: US 2020/0120089 A1
(43) Pub. Date: Apr. 16, 2020

(54) MULTIFACTOR AUTHENTICATION UTILIZING ISSUED CHECKS

(71) Applicant: CA, Inc., New York, NY (US)

(72) Inventors: CHANDRA SEKHAR VARANASI, HYDERABAD (IN); MURALI KRISHNA SEGU, HYDERABAD (IN); VINAY KUMAR TIRUVAIPETA, HYDERABAD (IN); JEETENDRA GOPAL VARANJANI, HYDERABAD (IN)

(21) Appl. No.: 16/158,009

(22) Filed: Oct. 11, 2018

(51) Int. Cl. H04L 29/06

(52) U.S. Cl. CPC H04L 63/0853; H04L 63/18; H04L 2463/082; H04L 63/0861; H04L 63/10

(57) ABSTRACT

A multifactor authentication system is implemented to enable interactive access to a secure application. A request to access a secure application can be received via a client device which can initially perform a credential exchange with a server associated with the secure application. Based on an indication that a credential exchange is valid, a secondary authentication request can to be sent to the client device to initiate multifactor authentication. An authentication check issued by an entity associated with the secure application can be scanned at the client device to, and an identification indicator associated with the authentication check and/or a signature of a user of the client device can be extracted. The identification indicator and the signature can be verified or otherwise authenticated, and access to the secure application via the client device can be enabled.

### BACKGROUND

Current authentication mechanisms, for example on a client device, generally utilize single factor authentication, or device generated authentication tokens for accessing secure applications and for performing sensitive transactions. However, single factor authentication is generally inadequate to authenticate user devices for heightened security applications. Additionally, introducing multiple single authentication factors (e.g. multiple stage authentication) causes inconvenience to end users and complicates the authentication process. Further, when performing authentication of a device, push notifications can be a security issue as anyone who has access to a user device can successfully access a secure application and perform a secure transaction.

### SUMMARY

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

Embodiments of the technology described herein are directed towards providing multifactor authentication for enabling access to a secure application where multiple factors are utilized during a single login or authentication event. In some embodiments, the present technology leverages an issued check leaf signed by the user requesting secure access as a multifactor authentication mechanism that combines a unique identifier that is not generated by the requesting device as well as biometric information associated with the user of the user of the requesting device.

According to some embodiments, a user device can receive a request to access a secure application associated with an entity. Based on an indication that a credential exchange has been verified, an entity security application can provide a multifactor authentication request to the user device. In response to the multifactor authentication request, an authentication check can be scanned by the user device. An agent running on the user device can extract one or more authentication features from the authentication check, for example an identification indicator associated with the authentication check and a signature of a user. The agent can subsequently send the extracted authentication elements or features to the entity security application which can perform validation and/or verification of the extracted authentication features. Access to the secure application via the user device can be enabled based on a successful validation and/or verification of the authentication features. Accordingly, through the use of authentication checks issued and registered by an entity providing access to a secure application, no additional enrollment is required for authentication and multifactor authentication can be accomplished in a single event, rather than multiple stages. In this way an improvement in authentication technology on a user device is realized through the use of multifactor authentication utilizing issued checks.

### BRIEF DESCRIPTION OF THE DRAWINGS

Aspects of the technology presented herein are described in detail below with reference to the attached drawing figures, wherein:

FIG. 1 is a diagram of an example operating environment in accordance with some aspects of the technology described herein;

FIG. 2 is a block diagram depicting an exemplary computing system and architecture, in accordance with some aspects of the technology described herein;

FIG. 3 is a block diagram of an exemplary computing system, in accordance with some aspects of the technology described herein;

FIG. 4 is a is a flow diagram showing a method for authenticating a user based on multifactor authentication utilizing an issued check, in accordance with some aspects of the technology described herein; and

FIG. 5 is a block diagram of an example computing environment suitable for use in implementing embodiments of the present invention.

### DETAILED DESCRIPTION OF THE INVENTION

The subject matter of aspects of the present disclosure is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” can be used herein to connote different elements of methods employed, the terms should not be interpreted as implying any particular order among or between various steps herein disclosed unless and except when the order of individual steps is explicitly described. As used herein, the singular forms “a,” “an,” and “the” are intended to include the plural forms as well, unless the context clearly indicates otherwise.

According to some aspects of the technology described herein, systems and methods are implemented for authenticating a user and/or user device based on multifactor authentication. As described herein, multifactor authentication can be achieved utilizing an authentication check issued by an entity associated with a secure application for which authentication of the user and/or user device is requested. The authentication check can comprise a plurality of authentication factors including, but not limited to, an identification indicator associated with the authentication check and a biometric indicator associated with a user of the user device, for example a user signature. The authentication check and the authentication indicators can be pre-registered by the entity providing the secure application and stored for authentication and/or verification, for example during an enrollment process.

A user device can receive a request to access the secure application provided by the entity based on an input by a user. In response to the request to access the secure application or otherwise interact with the secure application, a credential exchange can be performed between the user device and a server device associated with the entity providing the secure application. In some embodiments a request to access the secure application may be input through a browser running on the user device. The server device can provide an indication back to the user device that the credential exchange has been verified. Further an authentication request can be sent back to the user device, for example an out-of-band authentication request, to initiate or perform multifactor authentication. In some embodiments the authentication request is sent via an agent running on the user device (e.g. an authentication agent). Based on the authentication request, an authentication application can be initiated on the user device, for example by the authentication agent. In some embodiments the authentication application can provide a prompt to a user to initiate multifactor authentication.

Accordingly, an authentication check can be scanned by the user of the user device via an optical input device in communication with the user device. Based on the scanning the agent can extract one or more authentication features from the authentication check. For example, the agent can extract an identification indicator (e.g. unique number, watermark, etc.) associated with the authentication check and/or user of the user device. The agent can further extract a biometric marking associated with the authentication check and/or user of the user device (e.g. a signature of the user, a fingerprint of the user, etc.). Once the agent extracts the one or more authentication features from the authentication check, those features can be sent back to the server for validation and/or verification. In some embodiments, the authentication features are sent to an entity security application running on the entity server. Based on stored authentication features corresponding to the authentication check and/or user of the user device, the entity security application can verify and/or otherwise validate the identification indicator and/or the signature. If the verification and/or validation is completed, access to the secure application via the user device is enabled. If the verification and/or validation fails, access to the secure application via the user device is denied.

In some embodiments of the technology, the agent conducts a liveness check of the scanning operations. In this way it can be determined that the scan of the authentication check is completed in real time and that the scan is based on the live authentication check, rather than a copy or a picture of the authentication check. In other embodiments, the signature of the user can be provided in real time, for example a user can sign the check during the scanning operations or alternatively provide a signature to the user device via an electronic input.

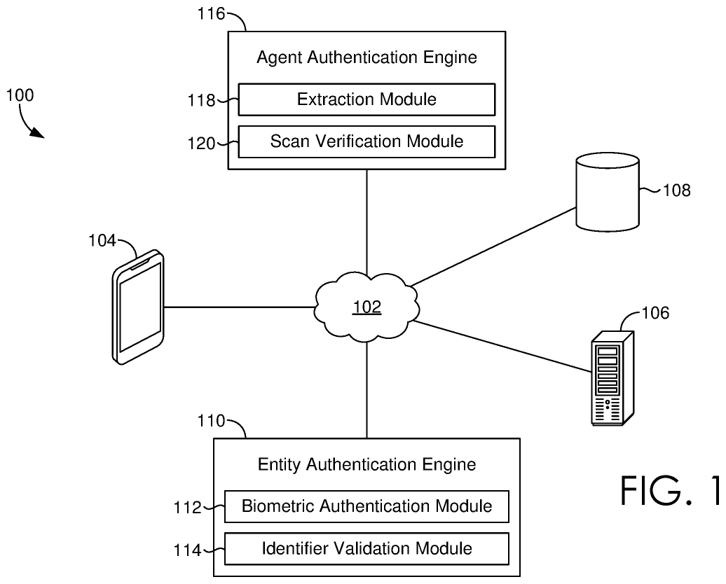

Referring now to the figures, with reference to FIG. 1, FIG. 1 depicts a block diagram of an exemplary computing environment 100 in which some embodiments of the present disclosure can be employed. It should be understood that this and other arrangements described herein are set forth only as examples. Other arrangements and elements (e.g., machines, devices interfaces, functions, orders, and groupings of functions) can be used in addition to or instead of those shown, and some elements can be omitted altogether for the sake of clarity. Further, many of the elements described herein are functional entities that can be implemented as discrete or distributed components or in conjunction with other components, and in any suitable combination and location. Various functions described herein as being performed by one or more entities can be carried out by hardware, firmware, and/or software. For instance, some functions can be carried out by a processor executing instructions stored in memory.

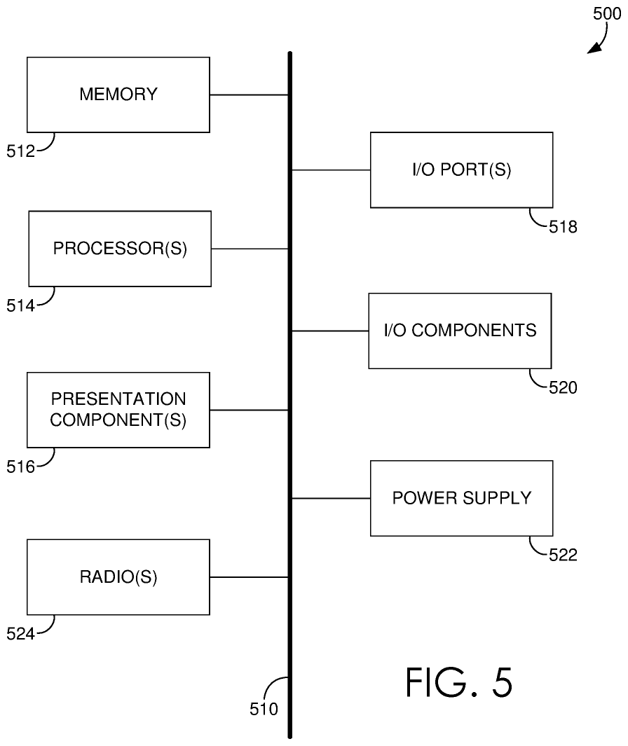

Among other components not shown, example operating environment 100 includes a user device, such as client device 104 and at least one application server or server system 106 associated with a secure application. Each of the components shown in FIG. 1 can be implemented via any type of computing device, such as computing device 500 described in connection to FIG. 5, for example. These components can communicate with each other via network 102, which can include, without limitation, one or more local area networks (LANs) and/or wide area networks (WANs). In exemplary implementations, network 102 comprises the Internet and/or a cellular network, amongst any of a variety of possible public and/or private networks.

It should be understood that any number of user devices, servers, and data sources can be employed within operating environment 100 within the scope of the present disclosure. Each can comprise a single device or multiple devices cooperating in a distributed environment. For instance, application server 106 can be provided via multiple devices arranged in a distributed environment that collectively provide the functionality described herein. Additionally, other components not shown can also be included within the distributed environment.

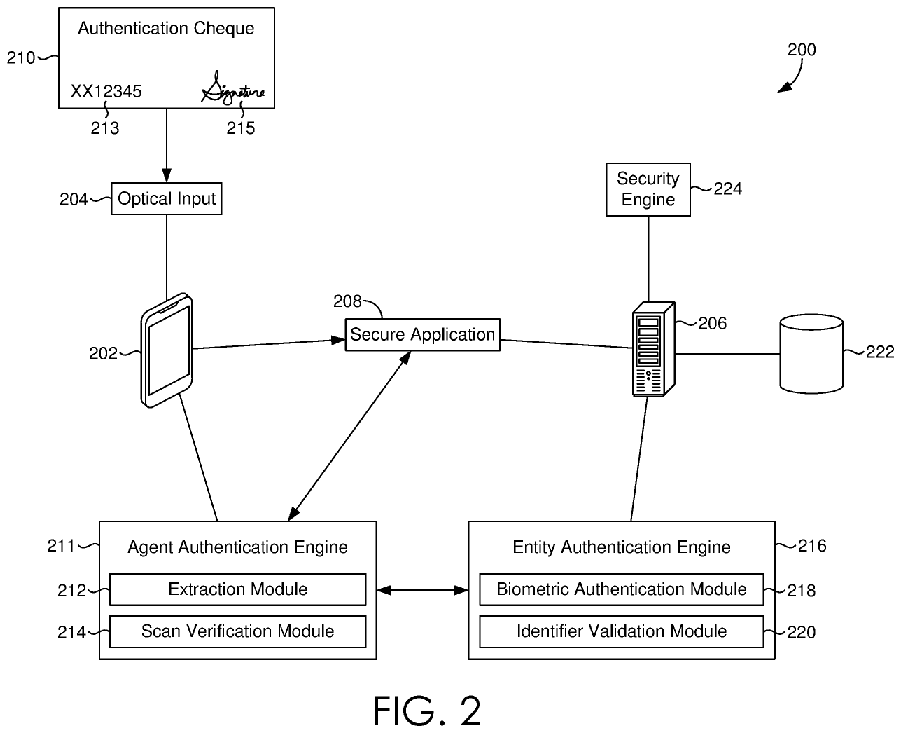

Client device 104 can comprise any type of computing device or user device capable of use by a user that includes an optical input device. By way of example and not limitation, a client device 104 can include an agent authentication engine 116 configured to run on the client device. The agent authentication engine 116 can comprise an extraction module 118 and a scan verification module 120. The extraction module 118 can operate in conjunction with the client device 104, and more particularly an optical input device or scanning device (e.g. a camera, an optical sensor, and the like). Extraction module 118 can scan and/or extract one or more features of an authentication check (e.g. authentication check 210 of FIG. 2) to be utilized for one or more authentication or verification processes. For example, extraction module 118 can, based on a scan of an authentication check, extract a unique identifier associated with the authentication check. The unique identifier can in some instances be a numerical or graphic marking. The scan verification module 120 can operate in conjunction with the client device 104, and more particularly an optical input device or scanning device of the client device 104. The scan verification module can in some embodiments perform a liveness check, for example a verification that authentication check being presented to the client device 104 and the features of the authentication check presented are done in real-time and are that of a verifiable object, and not a copy or imitation. The liveness check enables the agent authentication engine 116 and/or the entity authentication engine to discriminate between the real factors of the authentication check and artificial copies or imitations of those features, for example in this way spoofing of the authentication check through the use of photographs can be avoided.

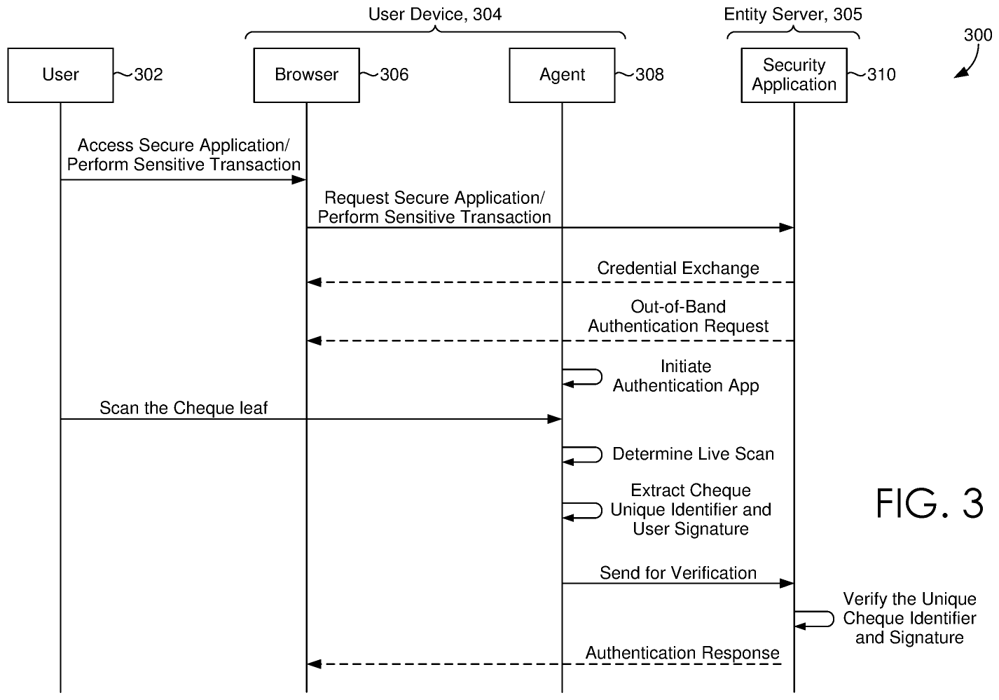

Data storage 108 can comprise data sources and/or data systems, which are configured to make data available to any of the various constituents of operating environment 100, or systems 200 and 300 described in connection to FIGS. 2 and 3. For example, in one embodiment, one or more data sources 108 can provide (or make available for access) datasets for use by any client device 104 and/or entity device, such as server 106. Data source 108 can be discrete from client device 104 and/or server 106 or can be incorporated and/or integrated into at least one of such components. In some embodiments, data source 108 can comprise a single dataset or a collection of datasets. In various embodiments, the data source 108 stores a shared collection of datasets that can be interpreted, analyzed, and/or processed by a client device 104 and/or entity server 106. According to some embodiments described herein, an authentication check can be pre-registered by the entity to aid in the authentication process. For example, pre-registering an authentication check can include storing an identification indicator in association with the signature of the user. Additionally, the client device itself can be uniquely mapped to the user by storing a client device identification is association with the identification indicator of the authentication check and/or the signature of the user.

Computing device and/or entity server 106 can be any computing device associated with an entity that is capable of running a secure application which can be accessed by a client device 104. The entity server 106 can be in operable communication with data storage 108. In some embodiments, data storage 108 can be a secure data store that is dedicated to entity server 106. The entity server 106 can be implemented to run and/or host one or more secure applications to be accessed by client device 104. The entity server 106 can comprise an entity authentication engine 110 to authenticate a client device 104 on the entity server 106 such that the client device can perform secure transactions with the entity server 106. The entity authentication engine 110 can comprise a biometric authentication module 112 and an identifier validation module 114. The biometric authentication module 112 can use biometric information extracted from an authentication check to verify the biometric information as part of an authentication process. The identifier validation module 114 can use identification information extracted from an authentication check to verify the unique identification marking of the authentication check as part of an authentication process. Access to a secure application associated with an entity can be enabled based on a verification of biometric information, identifier information, or both.

Continuing with FIG. 2, a block diagram depicting an exemplary computing system and architecture 200 is provided, in accordance with some aspects of the technology described herein. A user of a user device or client device 202 can be issued an authentication check 210 by an entity that requires an authentication process to access or interact with a secure application, such as secure application 208. The authentication check 210 can comprise a plurality of security features to be used in an authentication process, for instance an identification indicator 213 corresponding to the authentication check 210 and/or a biometric feature such as a user signature 215. A data store 222 associated with the entity and in communication with an entity server 206 can store the identification indicator 213 and/or the user signature in association with a client device 202 indicator and or other information corresponding to the user such as security credentials including, but not limited to, a username and a password.

Client device 202 can request to access a secure application 208 based on a user input to the client device 202. The secure application 208 can be stored on one or more servers 206 that are associated with an entity that provides the secure application 208. In response to a request to access secure application 208, a server 206 associated with the entity can send a request for an initial input of user credentials to client device 202 (e.g. via security engine 224). In response to a credential exchange with server 206, an out-of-band authentication request can be sent to client device 202, e.g. a request to perform multifactor authentication. In some embodiments the out-of-band request is sent by security engine 224.

Responsive to the multifactor authentication request sent by the entity server 206, a user of client device 202 can scan the authentication check 210 via optical input device 204 of client device 202. The optical input device 202 can scan any number of features of authentication check 210 as authentication data and provide such authentication data to the client device 202. In some embodiments, client device 202 comprises an agent authentication engine 211. The agent authentication engine 211 can include among other things an extraction module 212 and a scan verification module 212. The scan verification module 214 can be implemented to determine that the scan of authentication check 210 is performed in real time. In some embodiments scan verification module 214 can perform a liveness check to ensure that the authentication check is real and not a copy, picture, screen shot etc. In some embodiments secure printing processes (e.g. watermarks, microprinting, holograms, dyes, or any known security printing mechanism) can be employed such that when the optical input device 204 scans the authentication check 210 a determination can be made that the event is a real time live scan. In some embodiments additional steps can be required of the user, such as prompting a user to tilt, fold, or otherwise manipulate authentication check 210 during the scan. Extraction module 212 can operate in conjunction with the client device 202 and optical input device 204 to extract one or more authentication features from the authentication check 210, for example an identification indicator 213 and/or a user signature 215. In some embodiments the extraction module 212 can read and extract a water mark or other security features from authentication check 210. The client device 202 can send the extracted authentication features to the entity server 206 for verification.

The entity server 206 can comprise an entity authentication engine 216 to verify the extracted authentication features associated with the authentication check 210. The agent authentication engine 211 and the entity authentication engine 216 can operate in tandem to perform various authentication and validation functions. In some embodiments the entity authentication engine comprises biometric authentication module 218 and identifier validation module 220. Biometric authentication module 218 can receive the extracted user signature 215 and perform a validation of the signature, for example using biometric correlation matching. Identifier validation module 220 can receive the extracted identification indicator 213 and perform a validation of the unique identification indicator based on, for example, a matching function with a stored identification indicator. The entity authentication engine 216 can operate in conjunction with one or more data stores 222 to perform validation. In some embodiments, data store 222 contains a stored identification indicator and/or a stored user signature that are associated with a user and/or client device 202. The entity authentication engine 216 and the security engine 224, for example an entity security application, can upon verification of the identification indicator 213 and the user signature 215 enable access to the secure application 208 by the client device 202.

Turning now to FIG. 3, a schematic of an exemplary computing system 300 in operation for authenticating a user 302 and/or user device 304 based on multifactor authentication utilizing an entity issued check, in accordance with some aspects of the technology described herein, is depicted. A user device 304 comprising an optical input device (e.g. optical scanner, camera) can receive a request to access a secure application associated with an entity based on an input received from a user 302 of the user device 304, for example by requesting access via a browser 306 running on the user device 304. In some embodiments access can be requested via a mobile application associated with secure application 310. User device 304 can forward the request to a secure application 310. Secure application 310 can subsequently request one or more user credentials from the user device 304. A user 302 can input any number of user credentials or such user credentials can be stored at the user device 304. The user device 304 can perform a credential exchange with one or more security applications associated with the secure application 310 to be accessed. Based on an indication that the credential exchange has been verified or otherwise successful, an entity security application can send an out-of-band authentication request to an agent 308 running on the user device 304. In response to the out-of-band authentication request, and authentication application can be initiated on the user device 304 (e.g. agent authentication engine 211 of FIG. 2). A user 302 can scan an authentication check via an optical scanner of user device 304. In some embodiments, a determination can be made that the scanning is completed in real-time, for example by agent 308. Further, agent 308 can verify that the scanning of the authentication check is a live scan. Additionally, in some embodiments, the signature of the user may be input via user device 304 by user 302. Alternatively, user 302 may provide a signature on the authentication check during the scanning.

The authentication application (e.g. agent 308) running on user device 304 can extract a plurality of authentication features from the authentication check, for example an identification indicator associated with the authentication check and a signature of the user 302. Agent 308 can send the extracted identification indicator and the signature of the user to the entity security application 310. The entity security application 310 can verify the identification indicator and the signature extracted from the authentication check. If both the identification indicator and the signature of the user are verified or otherwise validated, access to the secure application can be enabled. If one or more of the authentication features extracted from the authentication check cannot be verified or otherwise validated then access to the secure application can be denied. In some embodiments, a message can be generated and sent to the user device and/or a device associated with the secure application indicating that access has been enabled or denied.

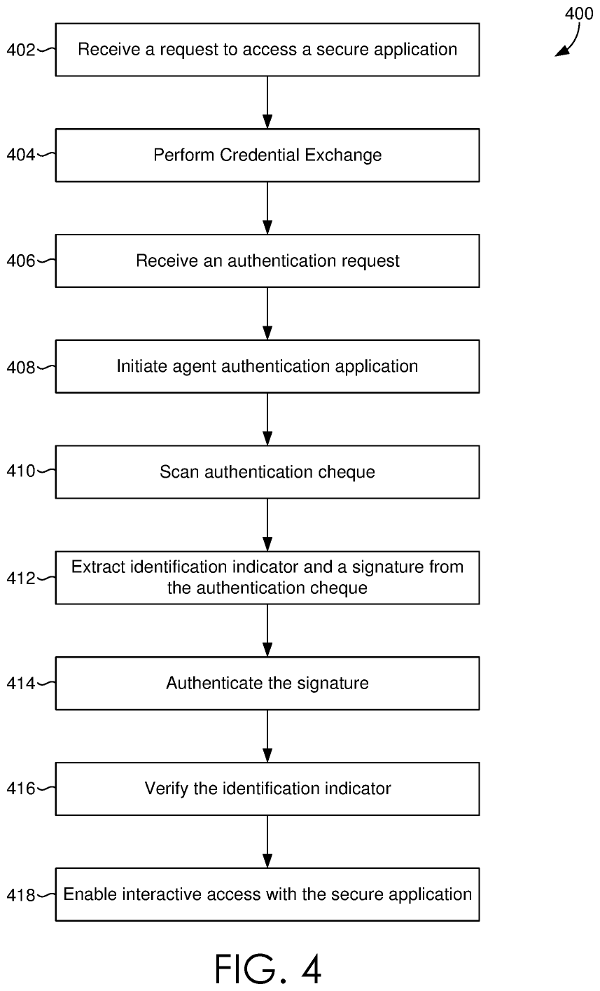

Turning now to FIG. 4, a flow diagram is provided illustrating one example method 400 for authenticating a user based on multifactor authentication utilizing an issued check, in accordance with some aspects of the technology described herein. It is contemplated that each block or step of method 400 and other methods described herein comprises a computing process that can be performed using any combination of hardware, firmware, and/or software. For instance, various functions can be carried out by a processor executing instructions stored in memory. The methods can also be embodied as computer-usable instructions stored on computer storage media. The methods can be provided by a stand-alone application, a plurality of interacting applications, a service or hosted service (stand-alone or in combination with another hosted service), or a plug-in to another product, to name a few.

At step 402, a request to access a secure application associated with an entity is received at a user device. In some embodiments, the request can be based on a direct or indirect user input to request an interaction with the secure application. At step 404, the user device and a server associated with the entity can perform a credential exchange. For example, credentials may be input by the user at the user device or they can be retrieved by the user device from internal memory or an external data store. Based on a verified or otherwise validated credential exchange between the user device and the entity server, at step 406 the user device can receive an out-of-band authentication request by an agent running on the user device. It will be appreciated that as used herein, an out-of-band authentication request in some embodiments is a distinct request from the initial request and credential exchange, where the out-of-band authentication request is received by the agent acting as an authentication agent. At step 408, based on the received authentication request, an agent authentication application can be initiated on the user device. In some embodiments, the initiation of the authentication application enables an optical input device of the user device.

At step 410, a user can scan, via the optical input device, an authentication check that can be associated with the user and/or the user device. At step 412, based on the scan of the authentication check, an identification indicator and/or a signature can be extracted from the authentication check. In some embodiments, the scanning and extracting can serve to generate a set of image verification data corresponding to the authentication check. At step 414 and step 416 the extracted signature and the extracted identification indicator can be authenticated and/or verified. In some embodiments, the generated verification data is authenticated. The authentication and/or verification can be completed as a single process, separate processes, or simultaneous processes. At step 418 interactive access to the secure application via the user device is enabled.

Having described various embodiments of the invention, an exemplary computing environment suitable for implementing embodiments of the invention is now described. With reference to FIG. 6, an exemplary computing device is provided and referred to generally as computing device 600. The computing device 600 is but one example of a suitable computing environment and is not intended to suggest any limitation as to the scope of use or functionality of the invention. Neither should the computing device 600 be interpreted as having any dependency or requirement relating to any one or combination of components illustrated.

Embodiments of the invention can be described in the general context of computer code or machine-useable instructions, including computer-useable or computer-executable instructions, such as program modules, being executed by a computer or other machine, such as a personal data assistant, a smartphone, a tablet PC, or other handheld device. Generally, program modules, including routines, programs, objects, components, data structures, and the like, refer to code that performs particular tasks or implements particular abstract data types. Embodiments of the invention can be practiced in a variety of system configurations, including handheld devices, consumer electronics, general-purpose computers, more specialty computing devices. Embodiments of the invention can also be practiced in distributed computing environments where tasks are performed by remote-processing devices that are linked through a communications network. In a distributed computing environment, program modules can be located in both local and remote computer storage media including memory storage devices.

With reference to FIG. 5, computing device 500 includes a bus 510 that directly or indirectly couples the following devices: memory 512, one or more processors 514, one or more presentation components 516, one or more input/output (I/O) ports 518, one or more I/O components 520, an illustrative power supply 522, and an illustrative radio 524 which can be implemented as a wireless communication device. Bus 510 represents what can be one or more buses (such as an address bus, data bus, or combination thereof). Although the various blocks of FIG. 5 are shown with lines for the sake of clarity, in reality, these blocks represent logical, not necessarily actual, components. For example, one can consider a presentation component such as a display device to be an I/O component. Also, processors have memory. The inventors hereof recognize that such is the nature of the art and reiterate that the diagram of FIG. 5 is merely illustrative of an exemplary computing device that can be used in connection with one or more embodiments of the present invention. Distinction is not made between such categories as “workstation,” “server,” “laptop,” “client device/system,” “user device,” “computing device,” or “server system,” as all are contemplated within the scope of FIG. 5.

Computing device 500 typically includes a variety of computer-readable media. Computer-readable media can be any available media that can be accessed by computing device 500 and includes both volatile and nonvolatile, removable and non-removable media. By way of example, and not limitation, computer-readable media can comprise computer storage media and communication media. Computer storage media includes both volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVDs) or other optical disk storage, magnetic cassettes, magnetic tape, magnetic disk storage or other magnetic storage devices, or any other medium which can be used to store the desired information and which can be accessed by computing device 500. Computer storage media does not comprise signals per se. Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media, such as acoustic, RF, infrared, and other wireless media. Combinations of any of the above should also be included within the scope of computer-readable media.

Memory 512 includes computer storage media in the form of volatile and/or nonvolatile memory. The memory can be removable, non-removable, or a combination thereof. Exemplary hardware devices include solid-state memory, hard drives, optical-disc drives. Computing device 500 includes one or more processors 514 that read data from various entities such as memory 512 or I/O components 520. Presentation component(s) 516 presents data indications to a user or other device. Exemplary presentation components include a display device, speaker, printing component, vibrating component, and the like.

The I/O ports 518 allow computing device 500 to be logically coupled to other devices, including I/O components 520, some of which can be built in. Illustrative components include a microphone, joystick, game pad, satellite dish, scanner, printer, wireless device. Some embodiments of computing device 500 can include one or more radio(s) 524 (or similar wireless communication components). The radio 524 transmits and receives radio or wireless communications. The computing device 500 can be a wireless terminal adapted to receive communications and media over various wireless networks. Computing device 500 can communicate via wireless protocols, such as code division multiple access (“CDMA”), global system for mobiles (“GSM”), or time division multiple access (“TDMA”), as well as others, to communicate with other devices. The radio communications can be a short-range connection, a long-range connection, or a combination of both a short-range and a long-range wireless telecommunications connection. When we refer to “short” and “long” types of connections, we do not mean to refer to the spatial relation between two devices. Instead, we are generally referring to short range and long range as different categories, or types, of connections (i.e., a primary connection and a secondary connection). A short-range connection can include, by way of example and not limitation, a Wi-Fi connection to a device (e.g., mobile hotspot) that provides access to a wireless communications network, such as a WLAN connection using the 802.11 protocol; a Bluetooth connection to another computing device is a second example of a short-range connection, or a near-field communication connection. A long-range connection can include a connection using, by way of example and not limitation, one or more of CDMA, GPRS, GSM, TDMA, and 802.16 protocols.

Many different arrangements of the various components depicted, as well as components not shown, are possible without departing from the scope of the claims below. Embodiments of the present invention have been described with the intent to be illustrative rather than restrictive. Alternative embodiments will become apparent to readers of this disclosure after and because of reading it. Alternative means of implementing the aforementioned can be completed without departing from the scope of the claims below. Certain features and sub-combinations are of utility and can be employed without reference to other features and sub-combinations and are contemplated within the scope of the claims.

What is claimed is:

1. A method comprising:
receiving, by a user device comprising an optical scanner, a request to access a secure application by a user;
based on an indication that a credential exchange has been verified, receiving, from an entity security application, an out-of-band authentication request at an agent running on the user device;
initiating an authentication application on the user device based on the out-of-band authentication request;
scanning an authentication cheque via the optical scanner of the user device;
based on the scanning, extracting by the agent an identification indicator associated with the authentication cheque and a signature of the user;
verifying, by the entity security application, the identification indicator and the signature; and
enabling access to the secure application via the user device.

2. The method of claim 1, further comprising: determining that the scanning of the authentication cheque is completed in real time.

3. The method of claim 1, further comprising: forwarding the request to an entity security application, the entity security application sending a credential request to the user device; and
based on access credential input received from the user, performing the credential exchange between the user device and the entity security application.

4. The method of claim 1, wherein the signature is received by the user device based on a user input interaction with the user device.

5. The method of claim 3, further comprising determining, by the entity security application, that the user device is unique to the user based on the credential exchange.

6. The method of claim 1, wherein the signature is authenticated by the entity security application based on a biometric correlation with a stored signature.

7. The method of claim 1, wherein the authentication check is issued by an entity associated with the entity security application.

8. The method of claim 1, wherein the identification indicator associated with the authentication cheque comprises a unique cheque number.

9. The method of claim 7, wherein the authentication cheque is pre-registered by the entity, the pre-registering comprising storing the identification indicator in association with the signature of the user.

10. A computer storage media, having instructions stored thereon that, when executed by at least one processor of a computing system, cause the computing system to:
receive, by a user device comprising an optical input device, a request to interact with a secure application via the user device, the request based on a user input;
based on a verified credential exchange between the user device and an entity security application, receive, from the entity security application, an out-of-band authentication request by an agent running on the user device;
initiate, by the agent, an authentication application on the user device;
scan, by the optical input device, an authentication cheque associated with the user of the user device;
based on the scan, generate image verification data corresponding to the authentication cheque;
authenticate, by the entity security application, the verification data; and
enable interaction with the secure application via the user device.

11. The computer storage media of claim 10, wherein the verification data comprises an identification indicator associated with the authentication cheque and a user signature.

12. The computer storage media of claim 10, further comprising: determining that the scan of the authentication cheque is completed in real-time.

13. The computer storage media of claim 10, further comprising: determining that the authentication cheque is a real object.

14. The computer storage media of claim 11, further comprising causing the system to authenticate the user signature by the entity security application based on a biometric correlation with a stored signature.

15. The computer storage media of claim 11, wherein the identification indicator is a unique check number issued by an entity associated with the entity security application.

16. The computer storage media of claim 11, wherein the authentication cheque is pre-registered by the entity, the pre-registering comprising storing the identification indicator in association with the signature of the user.

17. A computerized system for authenticating a user comprising:
a user device in communication with an optical input device, the user device comprising:
a processor; and
a computer storage medium storing computer-useable instructions that, when used by the processor, cause the processor to:
receive, by a user device comprising an optical input device, a request to interact with a secure application via the user device, the request based on a user input;
based on a verified credential exchange between the user device and an entity security application, receive, from the entity security application, an out-of-band authentication request by an agent running on the user device;
initiate, by the agent, an authentication application on the user device;
scan, by the optical input device, an authentication cheque associated with the user of the user device;
based on the scan, generate image verification data corresponding to the authentication cheque;
authenticate, by the entity security application, the verification data; and
enable interaction with the secure application via the user device.

18. The system of claim 17, wherein the verification data comprises an identification indicator associated with the authentication cheque and a user signature.

19. The system of claim 18, comprising causing the processor to:
authenticate the user signature by the entity security application based on a biometric correlation with a stored signature; and
authenticate the identification indicator by the entity security application based on a stored identification indicator that corresponds to the stored signature.

20. The system of claim 17, comprising causing the processor to determine that the scan of the authentication cheque is completed in real-time and that the authentication cheque is a real object
